(19) United States
(12) Patent Application Publication
(10) Pub. No.: US 2014/0190604 A1
(43) Pub. Date: Jul. 10, 2014

(54) PNEUMATIC TYRE PROVIDED WITH A TREAD BASED ON A THERMOPLASTIC ELASTOMER

(71) Applicants: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(72) Inventors: Emmanuel Custodero, Clermont-Ferrand Cedex 9 (FR); Vincent Lemal, Clermont-Ferrand Cedex 9 (FR); Jose Merino Lopez, Clermont-Ferrand Cedex 9 (FR); Sébastien Rigo, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/126,876

(22) PCT Filed: Jul. 20, 2012
(86) PCT No.: PCT/EP2012/064245

§ 371 Date: Jan. 29, 2014

(30) Foreign Application Priority Data
Jul. 21, 2011 (FR) 1156608

(51) Int. Cl. B60C 11/00

(52) U.S. Cl. CPC B60C 11/0008
USPC 152/209.1; 524/575

(57) ABSTRACT

The present invention relates to a tyre provided with a tread, such that the tread comprises at least one thermoplastic elastomer, which is a block copolymer comprising at least one elastomer block and at least one thermoplastic block, and hollow microparticles.

The present invention relates to treads for tyres and to the elastomer compositions used in the manufacture of such treads.

In a conventional tyre, the tread is based on predominantly diene elastomers.

A continual objective of tyre manufacturers is to improve the grip of the tyres on the ground while maintaining a very good level of road handling with regard to a motor vehicle.

In order to improve the road handling, a greater stiffness of the tread is desirable. However, such a stiffening of the tread, at the very least for its surface part which is in contact with the ground during the running of the tyre, is in a known way damaging to the dry grip properties but also to the grip properties on wet, snowy or icy ground.

There thus exists a compromise in performance to be optimized.

For this aim, the document WO 02/10269 provides a specific formulation for a tread based on a diene elastomer and on a reinforcing inorganic filler with a coupling agent and comprising methylene acceptors and methylene donors. The treads thus formed exhibit, after mechanical running in or accommodation, that is to say after contact of the tread on a ground under working conditions, for example straight-line running of a few tens or hundreds of meters, a stiffness gradient radially increasing from the surface towards the inside of the tread.

The Applicant Companies have found, surprisingly, another tread formulation capable of giving similar properties.

A subject-matter of the invention is a tyre provided with a tread. This tyre is characterized in that the said tread comprises at least one thermoplastic elastomer, the said thermoplastic elastomer being a block copolymer comprising at least one elastomer block and at least one thermoplastic block, the total content of thermoplastic elastomer being within a range varying from 65 to 100 phr (parts by weight per hundred parts of elastomer), and in that the said tread comprises hollow microparticles.

The presence of the hollow microparticles dispersed in the tread allows the surface part of the tread, after mechanical running in or accommodation, to have a substantial decrease in stiffness related to the rupturing of the hollow microparticles present. This tread thus exhibits a stiffness gradient increasing from the surface towards the inside which is very favourable to the grip performance of the tyre without damaging the vehicle handling performance.

The matrix of the tread of the tyre according to the invention predominantly comprises a block of thermoplastic elastomer. The preparation of the tread can thus be carried out in an extrusion tool and not in an internal mixer, such as those used for the preparation of the compositions based on normal diene elastomers. This makes it possible to limit the stresses undergone by the hollow microparticles during the preparation of the treads and thus to limit the ruptures of these microparticles during this preparation.

The invention relates more particularly to the tyres intended to equip motor vehicles of the following types: passenger vehicles, SUVs (Sport Utility Vehicles), two-wheel vehicles (in particular motorcycles), aircraft, as for industrial vehicles chosen from vans, heavy-duty vehicles—that is to say, underground trains, buses, heavy road transport vehicles (lorries, tractors, trailers) or off-road vehicles, such as agricultural vehicles or earth moving equipment—, or other transportation or handling vehicles.

### I. DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer. Within the meaning of the present invention, thermoplastic elastomers (TPEs) are included among the elastomers.

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### I-1. Composition of the Tread

The tyre according to the invention is provided with a tread having the essential characteristics of being based on at least one thermoplastic elastomer, as predominant elastomer, the said thermoplastic elastomer being a block copolymer comprising at least one elastomer block and at least one thermoplastic block, and of comprising hollow microparticles capable of breaking on running.

### I-1-A. Thermoplastic Elastomer (TPE)

Thermoplastic elastomers (abbreviated to “TPEs”) have a structure intermediate between thermoplastic polymers and elastomers. These are block copolymers composed of rigid thermoplastic blocks connected via flexible elastomer blocks.

The thermoplastic elastomer used for the implementation of the invention is a block copolymer, the chemical nature of the thermoplastic and elastomer blocks of which can vary.

### Structure of the TPE

The number-average molecular weight (denoted Mn) of the TPE is preferably between 30 000 and 500 000 g/mol, more preferably between 40 000 and 400 000 g/mol. Below the minima indicated, there is a risk of the cohesion between the elastomer chains of the TPE being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high weight Mn can be damaging to the use. Thus, it has been found that a value within a range from 50 000 to 300 000 g/mol was particularly well suited, in particular to use of the TPE in a tyre tread composition.

The number-average molecular weight (Mn) of the TPE elastomer is determined, in a known manner, by steric exclusion chromatography (SEC). For example, in the case of styrene thermoplastic elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel trade names (HMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the TPE is preferably less than 3, more preferably less than 2 and more preferably still less than 1.5.

In the present patent application, when reference is made to the glass transition temperature of the TPE, it concerns the Tg relative to the elastomer block. The TPE preferably exhibits a glass transition temperature (“Tg”) which is preferably less than or equal to 25° C., more preferably less than or equal to 10° C. A Tg value greater than these minima can reduce the performance of the tread when used at very low temperature; for such a use, the Tg of the TPE is more preferably still less than or equal to −10° C. Preferably again, the Tg of the TPE is greater than −100° C.

In a known way, TPEs exhibit two glass transition temperature peaks (Tg, measured according to ASTM D3418), the lowest temperature being relative to the elastomer part of the TPE and the highest temperature being relative to the thermoplastic part of the TPE. Thus, the flexible blocks of the TPEs are defined by a Tg which is less than ambient temperature (25° C.), while the rigid blocks have a Tg which is greater than 80° C.

In order to be both elastomeric and thermoplastic in nature, the TPE has to be provided with blocks which are sufficiently incompatible (that is to say, different as a result of their respective weights, their respective polarities or their respective Tg values) to retain their own properties of elastomer block or thermoplastic block.

The TPEs can be copolymers with a small number of blocks (less than 5, typically 2 or 3), in which case these blocks have high weights of greater than 15 000 g/mol. These TPEs can, for example, be diblock copolymers, comprising a thermoplastic block and an elastomer block. They are often also triblock elastomers with two rigid segments connected by a flexible segment. The rigid and flexible segments can be positioned linearly, or in a star or branched configuration. Typically, each of these segments or blocks often comprises a minimum of more than 5, generally of more than 10, base units (for example, styrene units and butadiene units for a styrene/butadiene/styrene block copolymer).

The TPEs can also comprise a large number of smaller blocks (more than 30, typically from 50 to 500), in which case these blocks have relatively low weights, for example from 500 to 5000 g/mol; these TPEs will subsequently be referred to as multiblock TPEs and are an elastomer block/thermoplastic block series.

According to a first alternative form, the TPE is provided in a linear form. For example, the TPE is a diblock copolymer: thermoplastic block/elastomer block. The TPE can also be a triblock copolymer: thermoplastic block/elastomer block/thermoplastic block, that is to say a central elastomer block and two terminal thermoplastic blocks, at each of the two ends of the elastomer block. Equally, the multiblock TPE can be a linear series of elastomer blocks/thermoplastic blocks.

According to another alternative form of the invention, the TPE of use for the requirements of the invention is provided in a star-branched form comprising at least three branches. For example, the TPE can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE is provided in a branched or dendrimer form. The TPE can then be composed of a branched or dendrimer elastomer block and of a thermoplastic block located at the end of the branches of the dendrimer elastomer block.

### Nature of the Elastomer Blocks

The elastomer blocks of the TPE for the requirements of the invention can be any elastomer known to a person skilled in the art. They may comprise a carbon-based chain (for example polyisoprene) or may not (for example silicones). They have a Tg of less than 25° C., preferably of less than 10° C., more preferably of less than 0° C. and very preferably of less than −10° C. Preferably again, the Tg of the elastomer block of the TPE is greater than −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say, a monomer comprising a carbon-carbon double bond. Mention may be made, among the blocks resulting from these ethylenic monomers, of polyalkylene blocks, such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is predominantly composed of ethylenic units. The term “predominantly” is understood to mean a highest content by weight of ethylenic monomer, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

In the case of unsaturated elastomer blocks, this elastomer block of the TPE is predominantly composed of a diene elastomer part. The term “predominantly” is understood to mean a highest content by weight of diene monomer, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type, which is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined above, or also a monomer such as vinyl acetate may be involved.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre tread.

The elastomer block can also be a block comprising several types of ethylene, diene or styrene monomers as defined above.

The elastomer block can also be composed of several elastomer blocks as defined above.

### Nature of the Thermoplastic Blocks

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, it will be necessary to consider that this is the temperature used to choose the processing temperature.

For the requirements of the invention, the TPE elastomers comprise one or more thermoplastic block(s) having a Tg of greater than or equal to 80° C. and formed from polymerized monomers. Preferably, this thermoplastic block has a Tg within a range varying from 80° C. to 250° C. Preferably, the Tg of this thermoplastic block is preferably from 80° C. to 200° C., more preferably from 80° C. to 180° C.

The proportion of the thermoplastic blocks, with respect to the TPE as defined for the implementation of the invention, is determined, on the one hand, by the thermoplasticity properties which the said copolymer has to exhibit. The thermoplastic blocks having a Tg of greater than or equal to 80° C. are preferably present in proportions sufficient to retain the thermoplastic nature of the elastomer according to the invention. The minimum content of thermoplastic blocks having a Tg of greater than or equal to 80° C. in the TPE can vary as a function of the conditions of use of the copolymer. On the other hand, the ability of the TPE to deform during the preparation of the tyre can also contribute to determining the proportion of the thermoplastic blocks having a Tg of greater than or equal to 80° C.

The thermoplastic blocks having a Tg of greater than or equal to 80° C. can be formed from polymerized monomers of various natures; in particular, they can constitute the following blocks or their mixtures:

polyolefins (polyethylene, polypropylene);

polyurethanes;

polyamides;

polyesters;

polyacetals;

polyethers (polyethylene oxide, polyphenylene ether);

polyphenylene sulphides;

polyfluorinated compounds (FEP, PFA, ETFE);

polystyrenes (described in detail below);

polycarbonates;

polysulphones;

polymethyl methacrylate;

polyetherimide;

thermoplastic copolymers, such as the acrylonitrile/butadiene/styrene (ABS) copolymer.

The thermoplastic blocks having a Tg of greater than or equal to 80° C. can also be obtained from monomers chosen from the following compounds and their mixtures:

acenaphthylene: a person skilled in the art may refer, for example, to the paper by Z. Fodor and J. P. Kennedy, Polymer Bulletin, 1992, 29(6), 697-705;

indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G Hager, Journal of Polymer Science, Part A, Polymer Chemistry (1992), 30, 41, and J. P. Kennedy, N. Meguriya and B. Keszler, Macromolecules (1991), 24(25), 6572-6577;

isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

The polystyrenes are obtained from styrene monomers. The term “styrene monomer” should be understood as meaning, in the present description, any monomer based on styrene, unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the content by weight of styrene in the TPE elastomer is between 5% and 50%. Below the minimum indicated, there is a risk of the thermoplastic nature of the elastomer being substantially reduced while, above the recommended maximum, the elasticity of the tread can be affected. For these reasons, the styrene content is more preferably between 10% and 40%.

According to an alternative form of the invention, the polymerized monomer as defined above can be copolymerized with at least one other monomer, so as to form a thermoplastic block having a Tg as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block.

According to the invention, the thermoplastic blocks of the TPE exhibit, in total, a number-average molecular weight (Mn) ranging from 5 000 g/mol to 150 000 g/mol, so as to confer, on the TPE, good elastomeric properties and a mechanical strength which is sufficient and compatible with the use as tyre tread.

The thermoplastic block can also be composed of several thermoplastic blocks as defined above.

### TPE Examples

For example, the TPE is a copolymer, the elastomer part of which is saturated and which comprises styrene blocks and alkylene blocks. The alkylene blocks are preferably ethylene, propylene or butylene. More preferably, this TPE elastomer is selected from the following group consisting of diblock or triblock copolymers which are or star-branched: linear or star-branched styrene/ethylene/butylene (SEB), linear or star-branched styrene/ethylene/propylene (SEP), linear or star-branched styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), linear or star-branched styrene/isobutylene (SIB), styrene/isobutylene/styrene (SIBS) and the mixtures of these copolymers.

According to another example, the TPE is a copolymer, the elastomer part of which is unsaturated and which comprises styrene blocks and diene blocks, these diene blocks being in particular isoprene or butadiene blocks. More preferably, this TPE elastomer is selected from the following group consisting of diblock or triblock copolymers which are linear or star-branched: linear or star-branched styrene/butadiene (SB), linear or star-branched styrene/isoprene (SI), linear or star-branched styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPE is a copolymer, the elastomer part of which comprises a saturated part and an unsaturated part, such as, for example, linear or star-branched styrene/butadiene/butylene (SBB), styrene/butadiene/butylene/styrene (SBBS) or a mixture of these copolymers.

Mention may be made, among multiblock TPEs, of the copolymers comprising random copolymer blocks of ethylene and propylene/polypropylene, polybutadiene/polyurethane (TPU), polyether/polyester (COPE) or polyether/polyamide (PEBA).

It is also possible for the TPEs given as example above to be mixed with one another within the tread according to the invention.

Mention may be made, as examples of commercially available TPE elastomers, of the elastomers of SEPS, SEEPS or SEBS type sold by Kraton under the Kraton G name (e.g., G1650, G1651, G1654 and G1730 products) or Kuraray under the Septon name (e.g., Septon 2007, Septon 4033 or Septon 8004), or also the elastomers of SIS type sold by Kuraray under the name Hybrar 5125 or sold by Kraton under the name D1161. Mention may also be made of the elastomers sold by Dexco Polymers under the Vector name (e.g., Vector 4114 or Vector 8508). Mention may be made, among multiblock TPEs, of the Vistamaxx TPE sold by Exxon; the COPE TPE sold by DSM under the Arnitel name or by DuPont under the Hytrel name or by Ticona under the Riteflex name; the PEBA TPE sold by Arkema under the PEBAX name; or the TPU TPE sold by Sartomer under the name TPU 7840 or by BASF under the Elastogran name.

### TPE Amount

If optional other (non-thermoplastic) elastomers are used in the composition, the TPE elastomer or elastomers constitute the predominant fraction by weight; they then represent at least 65% by weight, preferably at least 70% by weight and more preferably at least 75% by weight of the combined elastomers present in the elastomer composition. Preferably again, the TPE elastomer or elastomers represent at least 95% (in particular 100%) by weight of the combined elastomers present in the elastomer composition.

Thus, the amount of TPE elastomer is within a range which varies from 65 to 100 phr, preferably from 70 to 100 phr and in particular from 75 to 100 phr. Preferably again, the composition comprises from 95 to 100 phr of TPE elastomer. The TPE elastomer or elastomers are preferably the only elastomer or elastomers of the tread.

### I-1-B. Non-Thermoplastic Elastomer

The thermoplastic elastomer or elastomers described above are sufficient by themselves alone for the tread according to the invention to be usable.

The composition of the tread according to the invention can comprise at least one (that is to say, one or more) diene rubber as non-thermoplastic elastomer, it being possible for this diene rubber to be used alone or as a blend with at least one (that is to say, one or more) other non-thermoplastic rubber or elastomer.

The total content of optional non-thermoplastic elastomer is within a range varying from 0 to 35 phr, preferably from 0 to 30 phr, more preferably from 0 to 25 phr and more preferably still from 0 to 5 phr. Thus, when the tread comprises them, the non-thermoplastic elastomers represent at most 35 phr, preferably at most 30 phr, more preferably at most 25 phr and very preferably at most 5 phr. Very preferably again, the tread of the tyre according to the invention does not comprise a non-thermoplastic elastomer.

“Diene” elastomer or rubber should be understood as meaning, in a known way, a (one or more is understood) elastomer resulting at least in part (i.e., a homopolymer or a copolymer) from diene monomers (monomers carrying two carbon-carbon double bonds which may or may not be conjugated).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers such as some butyl rubbers or copolymers of dienes and of α-olefins of EPDM type can be described as “essentially saturated” diene elastomers (low or very low content of units of diene origin, always less than 15%).

Given these definitions, diene elastomer, whatever the above category, capable of being used in the compositions in accordance with the invention is understood more particularly to mean:
(a) any homopolymer obtained by polymerization of a conjugated diene monomer having from 4 to 12 carbon atoms;
(b) any copolymer obtained by copolymerization of one or more conjugated dienes with one another or with one or more vinylaromatic compounds having from 8 to 20 carbon atoms;
(c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d) a copolymer of isobutene and of isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the tread of the tyre according to the present invention.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-di ethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

### I-1-C. Hollow Microparticles

The second essential characteristic of the tread of the tyre according to the invention is to comprise hollow microparticles.

The term “hollow microparticles” is understood to mean hollow microparticles of varied constituent materials having a rigid shell. The hollow microparticles can comprise a liquid and preferably a gas inside, in particular air.

The hollow microparticles filled with a gas are characterized in particular by their bursting pressure.

The bursting pressure is measured by a test under nitrogen hydrostatic pressure. This method determines the percentage of reduction in volume of a sample of hollow microparticles when this sample is subjected to a given nitrogen pressure, the density of the hollow microparticles being known. A mixture of hollow microparticles and of talc is placed in a densitometer in order to measure the density thereof. The mixture is subsequently placed in a variable hydrostatic pressure test device and is subjected to a given nitrogen pressure cycle. At the end of the pressure cycle, the density of the mixture is measured and compared with the initial density. The percentage of survival of the hollow microparticles is then determined by the following formula:

$$\% S = 100 - \frac{( {P}_{F} - {P}_{I} ) ( B + T ) \times 100}{{P}_{F} ( B + T - \frac{{P}_{I}}{{P}_{T}} T )}$$

in which P_{I} is the initial density of the mixture, P_{F} is the final density of the mixture, P_{T} is the density of the talc, B is the weight of hollow microparticles in the mixture and T is the weight of talc in the mixture.

The bursting pressure (“crush test”) of the hollow microparticles which are mentioned in this document corresponds to the hydrostatic pressure at which a percentage of survival (“target survival of about 90%”) of the order of 90% is measured using the test method described above.

Preferably, the bursting pressure is preferably less than 800 bar. This is because it has been found that, above this value, the mechanism of running in the tread is no longer sufficiently pronounced due to the very high resistance to rupturing of the hollow microparticles.

Preferably, the hollow microparticles have a bursting pressure of greater than 200 bar. This is because, when the bursting pressure is less than 200 bar, it has been found that many of these hollow microparticles are broken during the preparation of the tread.

Very preferably, the bursting pressure is greater than 300 bar; this makes it possible to limit the number of hollow microparticles broken during the preparation of the tread.

The hollow microparticles can preferably be chosen from the group of hollow glass, ceramic, metal, silica, alumina and zirconia microparticles and their mixtures.

Preferably, hollow glass and/or ceramic microparticles are used.

The content of hollow microparticles of the tread can be between 1% and 40% by volume and preferably between 5% and 35% by volume. Below 1%, the effect of the microspheres becomes insufficient and, above 40%, the preparation of the tread with a satisfactory dispersion of the hollow microparticles becomes difficult.

The hollow microparticles can have any useful shape. In many embodiments, the hollow microparticles have a spherical, oblong or elliptical shape. In specific embodiments, the hollow microparticles have a spherical shape and are described as hollow microspheres.

The volume-average diameter of the hollow microparticles is within the range from 5 to 500 microns. In the case of hollow glass or ceramic microspheres, this volume-average diameter is preferably between 20 and 150 microns. Below 20 microns, the resistance to rupture of the hollow microparticles is too high and, above 150 microns, it is the reverse. In both cases, the running-in mechanism is no longer sufficiently pronounced.

According to their characteristics of bursting pressure, of material nature and of geometry, the density of the hollow microparticles varies between 0.3 and 2.

The lower the density, while retaining a sufficient bursting pressure, the more substantial the effect of the hollow microparticles after mechanical running-in. A density of between 0.3 and 0.4 is thus particularly advantageous for hollow glass or ceramic microspheres.

Examples of hollow microspheres made of glass are available from 3M under the references: 3M™ Glass Bubbles S32, S38, S38HS and S60HS. Examples of hollow microspheres made of ceramic are available from Trelleborg Fillite under the references: 106 and 160.

### I-1-D. Nanometric or Reinforcing Filler

The thermoplastic elastomer described above is sufficient by itself alone as elastomer for the tread according to the invention to be usable.

When a reinforcing filler is used, use may be made of any type of filler generally used for the manufacture of tyres, for example an organic filler, such as carbon black, an inorganic filler, such as silica, or also a blend of these two types of filler, in particular a blend of carbon black and silica.

All the carbon blacks conventionally used in tyres (“tyre-grade” blacks) are suitable as carbon blacks. Mention will more particularly be made, for example, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772), indeed even N990.

The term “reinforcing inorganic filler” should be understood, in the present patent application, by definition, as meaning any inorganic or mineral filler, whatever its colour and its origin (natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, the term “reinforcing inorganic filler” is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention will be made, as highly dispersible precipitated silicas (HDSs), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface as described in Application WO 03/16837.

In order to couple the reinforcing inorganic filler to the elastomer, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

The content by volume of reinforcing filler in the composition (carbon black and/or reinforcing inorganic filler, such as silica) is within a range from 0% to 20%, which corresponds to a content of 0 to 50 phr for a plasticizer-free composition. Preferably, the composition comprises less than 30 phr of reinforcing filler and more preferably less than 10 phr. According to a preferred alternative form of the invention, the composition does not comprise a reinforcing filler.

### I-1-E. Plasticizers

The thermoplastic elastomer described above is sufficient by itself alone as elastomer for the tread according to the invention to be usable.

However, according to a preferred embodiment of the invention, the elastomer composition described above can also comprise a plasticizing agent, such as an extending oil (or plasticizing oil) or a plasticizing resin, the role of which is to facilitate the processing of the tread, in particular its incorporation in the tyre, by a lowering of the modulus and an increase in the tackifying power.

Use may be made of any extending oil, preferably having a weakly polar nature, capable of extending or plasticizing elastomers, in particular thermoplastic elastomers. At ambient temperature (23° C.), these oils, which are more or less viscous, are liquids (that is to say, as a reminder, substances which have the ability to eventually assume the shape of their container), in contrast in particular to resins or rubbers, which are by nature solids. Use may also be made of any type of plasticizing resin known to a person skilled in the art.

For example, the extending oil is selected from the group consisting of paraffinic oils, such as a low viscosity paraffinic oil (LVPO).

A person skilled in the art will know, in the light of the description and implementational examples which follow, how to adjust the amount of plasticizer as a function of the TPE elastomer used (as indicated above) and of the specific conditions of use of the tyre provided with the tread, and in particular as a function of the tyre in which it is intended to be used.

When it is used, it is preferable for the content of extending oil to vary from 0 to 80 phr, more preferably from 0 to 50 phr, according to the targeted Tg and the targeted modulus.

### I-1-F. Various Additives

The tread described above can furthermore comprise the various additives normally present in treads known to a person skilled in the art. Mention will be made, for example, of inert micrometric fillers, such as the lamellar fillers known to a person skilled in the art, protection agents, such as antioxidants or antiozonants, UV stabilizers, various processing aids or other stabilizers, or also promoters capable of promoting the adhesion to the remainder of the structure of the tyre. Equally and optionally, the composition of the tread of the invention can comprise a crosslinking system known to a person skilled in the art. Preferably, the composition does not comprise a crosslinking system.

In addition to the elastomers described above, the composition of the tread might also comprise, always according to a minor fraction by weight with respect to the block elastomer, polymers other than elastomers, such as, for example, thermoplastic polymers, and in particular poly(para-phenylene ether) polymers (denoted by the abbreviation “PPE”). These PPE thermoplastic polymers are well known to a person skilled in the art; they are resins, which are solid at ambient temperature (20° C.) and which are compatible with styrene polymers, which have been used in particular to increase the Tg of TPE elastomers, the thermoplastic block of which is a styrene block (see, for example, “Thermal, Mechanical and Morphological Analyses of Poly(2,6-dimethyl-1,4-phenylene oxide)/Styrene-Butadiene-Styrene Blends”, Tucker, Barlow and Paul, Macromolecules, 1988, 21, 1678-1685).

### I-2. Preparation of the Tread

The tread which is a subject-matter of the invention can be processed by any mixing process, in particular by any liquid-phase mixing process, in particular processes employing weak shearing. It can also be processed, conventionally for TPEs, by extrusion or moulding, for example using a starting material available in the form of beads or granules.

The tread for the tyre according to the invention is prepared, for example, by incorporation of the various components in a twin-screw extruder, so as to carry out the melting of the matrix and the incorporation of all the ingredients, followed by the use of a die which makes it possible to produce the profiled elements. The means and conditions used have to be adapted in order not to break the microspheres during the processing. In particular, it is important to introduce the microspheres into the body of the extruder only when the TPE is completely molten. The tread is subsequently moulded in the mould for curing the tyre.

If the elastomer block of the TPE is a saturated elastomer block, it may be necessary to include, in the tyre, an adhesion layer under the tread which will comprise a TPE having unsaturated elastomer block in order to promote the adhesion between the said tread and the adjacent layer within the finished tyre.

This tread can be conventionally fitted to a tyre, the said tyre comprising, in addition to the tread according to the invention, a crown, two sidewalls and two beads, a carcass reinforcement anchored to the two beads, and a crown reinforcement. Optionally and as indicated above, the tyre according to the invention can additionally comprise an underlayer or an adhesion layer between the tread and the crown.

### II. EXAMPLES OF THE IMPLEMENTATION OF THE INVENTION

Tread compositions for a tyre according to the invention were prepared as indicated above with an SBS thermoplastic elastomer matrix (SOLT 166 from Europrene) introduced into a twin-screw extruder with a screw temperature of 180° C. which makes possible the melting of the thermoplastic matrix and the shaping thereof. The hollow microparticles are introduced into the extruder downstream of the thermoplastic elastomer matrix, so that the latter is already completely molten. Hollow microparticles of several natures have been used, glass microspheres and ceramic microspheres. The introduction of the hollow microspheres is carried out sufficiently early within the twin-screw in order for their dispersion to be carried out correctly. A flat die is positioned at the head of the twin-screw extruder in order to obtain the profiled elements necessary for the preparation of a tyre tread.

Observation of the hollow microspheres within the profiled elements can be carried out by electron microscopy; the hollow microspheres, and in some cases their destruction, are easily distinguished. More specifically, we have observed that, when the bursting pressure of the hollow microspheres is less than 200 bar, numerous smashed hollow microspheres are observed; on the other hand, when the bursting pressure is greater than 300 bar, a very great majority of the hollow microspheres are intact after the stage of producing the composition.

The characteristics of the hollow microparticles tested, suppliers given, are given in Table 1.

TABLE 1

| | | | | | Mean |
|---|---|---|---|---|---|
| | | Bursting pressure | | | density |
| | | (Target Crush Strength | | | of the |
| | | (90% survival)) | | Diameters | particles |
| Nature | Reference | psi | bar | (μm) | (g/cm³) |
| Glass | S32 | 2000 | 138 | 20-80 | 0.29-0.35 |
| 3M ™ | S38 | 4000 | 276 | 15-85 | 0.35-0.41 |
| Glass | S38 HS | 5500 | 380 | 19-85 | 0.35-0.41 |
| Bubbles | S60 | 10,000 | 690 | 15-65 | 0.57-0.63 |
| Ceramic | 106 | 1500-3000 | 105-210 | 5-106 | 0.65-0.85 |
| Trelleborg | 160 | 1500-3000 | 105-210 | 5-180 | 0.65-0.85 |
| Fillite ® | | | | | |

The formulations of the tread mixtures tested are presented in Table 2. The control is the composition C-01, which comprises only a thermoplastic elastomer, Europrene SOLT 166. All the other mixtures have the same matrix to which glass or ceramic microspheres have been added at a content of 30% by volume. The contents of the hollow microspheres, in phr, have been shown in brackets.

TABLE 2

| Trade names | C-01 | C-02 | C-03 | C-04 | C-05 | C-06 | C-07 |
|---|---|---|---|---|---|---|---|
| Europrene SOLT 166 (phr) | 100 | 100 | 100 | 100 | 100 | 100 | 100 |
| 3M Glass Bubbles - S60 | | 30 | | | | | |
| % by volume (phr) | | (27.1) | | | | | |
| 3M Glass Bubbles - S38 | | | 30 | | | | |
| % by volume (phr) | | | (17.1) | | | | |
| 3M Glass Bubbles - S38HS | | | | 30 | | | |
| | | | | (17.1) | | | |
| 3M Glass Bubbles - S32 | | | | | 30 | | |
| % by volume (phr) | | | | | (14.4) | | |
| Trelleborg Fillite 106 | | | | | | 30 | |
| % by volume (phr) | | | | | | (27.1) | |
| Trelleborg Fillite 160 | | | | | | | 30 |
| % by volume (phr) | | | | | | | (29.3) |

Tyres according to the invention were subsequently prepared according to the usual methods, with the conventional constituents known to a person skilled in the art: a crown, two sidewalls and two beads, a carcass reinforcement anchored to the two beads, a crown reinforcement and a tread, the tread being that described for the requirements of the present invention.

After vulcanization of the tyres, a measurement of the Shore A hardness of the treads is carried out for the various compositions tested. The tyres are subsequently subjected to running for 100 km and a second measurement of Shore A hardness is carried out. The measurements of Shore A hardness are carried out according to Standard ASTM D 2240.

The measurements of Shore A hardness carried out before and after the running are given in Table 3.

TABLE 3

| | 1st Shore A | 2nd Shore A | Shore A |
|---|---|---|---|
| Composition | measurement | measurement | difference |
| C-01 | 70.6 | 66.2 | −4.4 |
| C-02 | 78.8 | 70.9 | −7.9 |
| C-03 | 76.8 | 64.8 | −12.0 |
| C-04 | 74.7 | 63.8 | −10.9 |
| C-05 | 74.6 | 65.1 | −9.5 |
| C-06 | 76.0 | 67.2 | −8.8 |
| C-07 | 77.2 | 67.9 | −9.3 |

All the treads experience a decrease in their Shore hardness after running for 100 km. This accommodation phenomenon is well known and is always observed on the treads but the variation is on average twice as great for the compositions comprising hollow microspheres than for the tread not comprising them.

Observations by electron microscopy were carried out on the treads after running for 100 km. These observations showed that many hollow microspheres were smashed in the thin surface layer of the tread, that is to say in the 2 to 3 mm of surface, whereas, at depth, the great majority of them were intact.

The decrease in Shore A hardness is thus indeed the consequence of the rupture in the thin surface layer of the tread of the hollow microspheres due to the high local pressures related to running over rough ground. The presence of the hollow microspheres thus effectively makes it possible to create, during the running, a stiffness gradient of the tread favourable for the grip properties without damaging the handling of the vehicle since the stiffness of the mixture is not affected in its bulk, the hollow microspheres not being detrimentally affected.

A person skilled in the art will know how to adjust the content and the nature of the hollow microparticles in order to obtain the expected decrease in stiffness as a function of the grip effect desired and of the operating conditions (types of tyres, running operations).

1-26. (canceled)

27. A tyre comprising a tread, the tread including:
at least one thermoplastic elastomer,
wherein the at least one thermoplastic elastomer is a block copolymer that includes at least one elastomer block and at least one thermoplastic block, and
wherein a total content of the at least one thermoplastic elastomer is within a range of from 65 to 100 phr (parts by weight per hundred parts of elastomer), and
hollow microparticles.

28. The tyre according to claim 27, wherein a bursting pressure of the hollow microparticles is less than 800 bar.

29. The tyre according to claim 27, wherein a bursting pressure of the hollow microparticles is greater than 200 bar.

30. The tyre according to claim 29, wherein the bursting pressure of the hollow microparticles is greater than 300 bar.

31. The tyre according to claim 28, wherein the bursting pressure of the hollow microparticles is between 300 and 600 bar.

32. The tyre according to claim 27, wherein the hollow microparticles are any one or any mixture of: hollow glass microparticles, hollow ceramic microparticles, hollow metal microparticles, hollow silica microparticles, hollow alumina microparticles, and hollow zirconia microparticles.

33. The tyre according to claim 32, wherein the hollow microparticles are any one or any mixture of: hollow glass microparticles and hollow ceramic microparticles.

34. The tyre according to claim 27, wherein a content of the hollow microparticles in the tread is between 1% and 40% by volume.

35. The tyre according to claim 34, wherein the content of the hollow microparticles in the tread is between 5% and 35% by volume.

36. The tyre according to claim 27, wherein the hollow microparticles include hollow microspheres.

37. The tyre according to claim 27, wherein a number-average molecular weight of the at least one thermoplastic elastomer is between 30,000 and 500,000 g/mol.

38. The tyre according to claim 27, wherein the at least one elastomer block of the block copolymer is or are chosen from elastomers having a glass transition temperature of less than 25° C.

39. The tyre according to claim 27, wherein the at least one elastomer block of the block copolymer is or are selected from a group consisting of: ethylene elastomers, diene elastomers, and mixtures thereof.

40. The tyre according to claim 27, wherein the at least one elastomer block of the block copolymer is or are chosen from ethylene elastomers.

41. The tyre according to claim 27, wherein the at least one elastomer block of the block copolymer is or are chosen from diene elastomers.

42. The tyre according to claim 41, wherein the at least one elastomer block of the block copolymer is or are chosen from diene elastomers resulting from isoprene, or butadiene, or a mixture of isoprene and butadiene.

43. The tyre according to claim 27,
wherein the at least one thermoplastic block of the block copolymer is or are chosen from polymers having a glass transition temperature of greater than 80° C., and
wherein, if the at least one thermoplastic block is a semicrystalline thermoplastic block, the semicrystalline thermoplastic block has a melting point of greater than 80° C.

44. The tyre according to claim 27, wherein the at least one thermoplastic block of the block copolymer is or are selected from a group consisting of: polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers, and mixtures thereof.

45. The tyre according to claim 27, wherein the at least one thermoplastic block of the block copolymer is or are chosen from polystyrenes.

46. The tyre according to claim 27, wherein the at least one thermoplastic elastomer is or are selected from a group consisting of: styrene/butadiene (SB) thermoplastic elastomers, styrene/isoprene (SI) thermoplastic elastomers, styrene/butadiene/isoprene (SBI) thermoplastic elastomers, styrene/butadiene/styrene (SBS) thermoplastic elastomers, styrene/isoprene/styrene (SIS) thermoplastic elastomers, and styrene/butadiene/isoprene/styrene (SBIS) thermoplastic elastomers, and mixtures thereof.

47. The tyre according to claim 27, wherein the tread includes no elastomer other than the at least one thermoplastic elastomer.

48. The tyre according to claim 27, wherein the tread includes at least one non-thermoplastic elastomer at a total content of at most 35 phr.

49. The tyre according to claim 27, wherein the tread includes at least one plasticizing agent.

50. The tyre according to claim 49, wherein the at least one plasticizing agent includes one or both of: a plasticizing resin and a plasticizing oil.

51. The tyre according to claim 50, wherein the plasticizing oil is a paraffinic oil.

52. The tyre according to claim 27, further comprising:
a crown;
two sidewalls;
two beads;
a carcass reinforcement anchored to the two beads; and
a crown reinforcement.
